(19) United States
(12) Patent Application Publication
(10) Pub. No.: US 2005/0128209 A1
(43) Pub. Date: Jun. 16, 2005

(54) Using texture filtering for edge anti-aliasing

(76) Inventors: Kornelius Meinds, Eindhoven (NL); Bart Gerard Bernard Barenbrug, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/503,336

(22) PCT Filed: Jan. 30, 2003
(86) PCT No.: PCT/IB03/00328

(30) Foreign Application Priority Data
Feb. 1, 2002 (EP) 02075420.6

(51) Int. Cl. G06T 15/20; G06T 15/10; G09G 5/00

(52) U.S. Cl. 345/582; 345/427; 345/611

(57) ABSTRACT

Computer graphics processing operations are executed on information relating to a model of one or more three-dimensional objects which includes texture information. The method includes a rendering step that comprises a transformation step allowing for both affine and non-affine two-dimensional image transformations, and comprises transforming the texture information. This uses a filtering step to suppress aliasing artifacts of interior parts of one or more textured primitives in the rendered image. In particular, the method uses the filtering to deliver partial colours at both sides of the edges of such primitive. Eventually, aggregation of the partial colours suppresses artifacts from edge aliasing of the primitive in question.

### BACKGROUND OF THE INVENTION

The invention relates to a method for executing a processing operation on information that relates to a model of one or more three-dimensional objects as has furthermore been recited in the preamble of claim 1. Computer graphics are widely used nowadays, and the application of both affine and non-affine coordinate transformations is useful in computer video games, spatial simulation, engineering and other fields.

Now, the inventors have recognized the need for providing a straightforward, inexpensive procedure to execute conversion for such purposes, and in particular for minification purposes. By itself, Sample Rate Conversion has been disclosed in U.S. Pat. No. 5,892,695 to Van Dalfsen et al, and assigned to the present assignee, such being effected through using a transposed structure, with the object of obtaining anti-aliased, transformed video images. A particular purpose of the present invention is to avoid aliasing in the transformed images.

Broadly formulated, an alias is an item in the resulting image that should not be there. In the context of the present invention, aliasing is generally exhibited as a saw-tooth or stepping character of the edge of a primitive that should have been a smooth line or curve, or by pixel colour faults at or near such edge, which faults present a different colour from the one intended. Technically, aliasing occurs when sampling a signal such as a perspectively transformed texture map, for example by a pixel grid on a screen. The problem manifests itself when the signal contains a frequency which is too high to be represented in the discrete signal. Aliasing can be removed by filtering out these samples before sampling, through using a so-called prefilter.

In the discussion hereinafter, a pixel is a size-less location on the ultimate representation such as screen or print, and the pixels are separated from each other according to a pixel spacing pattern dictated by the array configuration. A sample has both a coordinate and a value. A fragment contains information that contributes to the eventual texel. A texel is the sampled information from the original description of the model. A primitive is a self-consistent element in the original model that is used as a description on which, possibly in combination with other primitives, a set of edges in the eventual image will be based. Such primitives may be triangles, quadrilaterals and other polygons, surfaces with curved edges such as Bezier patches that need not be restricted to being flat, and other items as the case may be.

Now, the present inventors have recognized that texels from both sides of the original edge could through sampling and filtering contribute to the eventual pixels at either side of the resulting edge. Therefore, as governed by the filter curves used, texels from both sides of edges in the model should be allowed to deliver partial colours for assembling the eventually resulting image.

### SUMMARY TO THE INVENTION

In consequence, amongst other things, it is an object of the present invention to derive such partial colours in a straightforward manner, and in particular, letting information from both sides of the primitive edges contribute to the eventual pixels.

Now therefore, according to one of its aspects the invention is characterized according to the characterizing part of claim 1.

The invention also relates to a system that is arranged for implementing a method as claimed in claim 1. Further advantageous aspects of the invention are recited in dependent claims.

### BRIEF DESCRIPTION OF THE DRAWING

These and further aspects and advantages of the invention will be discussed more in detail hereinafter with reference to the disclosure of preferred embodiments, and in particular with reference to the appended Figures that show:

FIG. 1, a diagram of a back-end of an input sampledriven processing pipeline;

FIG. 2, a more detailed view of the fragment buffer that forms part of the pixel fragment operations of FIG. 1;

FIG. 3, a diagram of an interval filtering procedure for a one-dimensional case;

FIG. 4, a diagram of an edge-filtering procedure for a one-dimensional case;

FIGS. 5a, 5b, an exemplary rasterization in texture space;

FIGS. 6a, 6b, the pixels that are to be contributed with a certain texel;

FIG. 7, the contributions from various texels;

FIGS. 8a, 8b, the positions of left face “edge pixels” of a polygon;

FIGS. 9a, 9b, the same for only the texels in the prefilter footprint and within the polygon that should contribute.

### DETAILED DESCRIPTION OF PREFERRED EMBODIMENTS

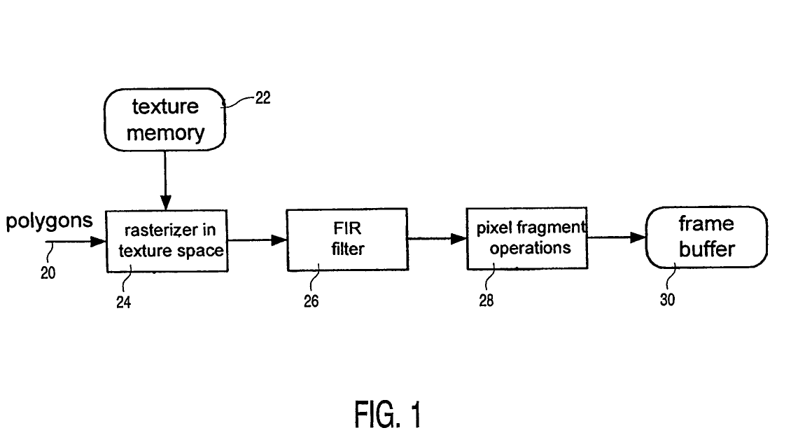

FIG. 1 illustrates a diagram of a backend of an input sample-driven processing pipeline. Herein, the polygon information 20 is inputted at the left hand side into the rasterizer in texture space 24. The generation of such polygon information is by itself state of the art. For the purpose of the rasterizing, a texture memory 22 presents the necessary texture information. After rasterizing, the information is subjected to filtering by a finite impulse response FIR filter 26. After the filtering, the various pixel fragments that have been separately generated in the earlier stages, are now combined in an appropriate manner for producing the eventual information of the screen pixel in question. These pixel fragment operations are executed in block 28. After the combination, the screen image is stored in frame buffer 30 for subsequent usage, such as visual display.

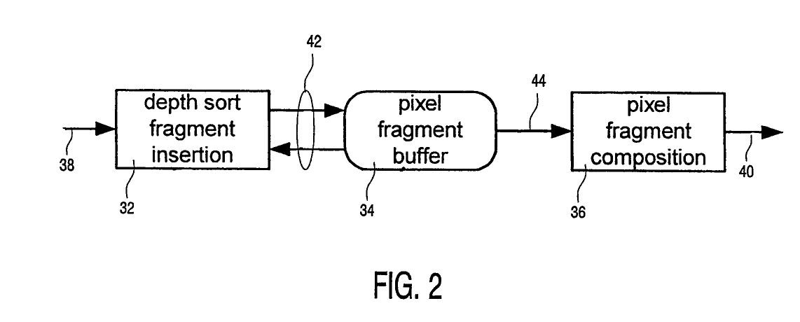

FIG. 2 illustrates a more detailed view of the situation of the fragment buffer that is part of the pixel fragment operations module of FIG. 1. At the left, input 38 receives the output from FIR filter 26 in FIG. 1. In block 32, a depth sort fragment insertion is executed. This will determine whether a particular fragment is locally “before” or locally “behind” another primitive. In the former two cases, the procedure will also take into account whether a particular primitive is transparent or opaque. Certain other criteria could also play roles, but this is ignored for brevity. After insertion, the information of the various pixel fragments, the pixel fragments are forwarded in the pixel fragment buffer. After all the primitives have been processed and their fragments inserted in the fragment buffer the sorted pixel fragments are outputted on output 44 for composition to the eventual pixel information in module 36. After composition, the resulting pixel information is outputted on interconnection 40 to frame buffer 30 in FIG. 1.

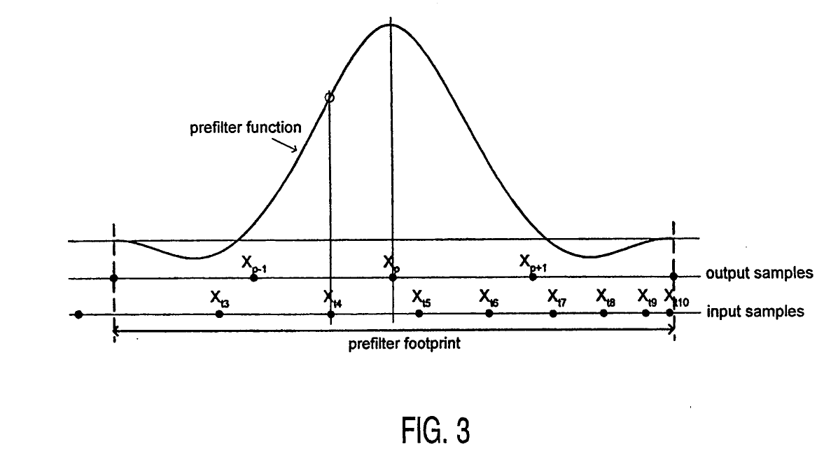

FIG. 3 illustrates a graph of a filtering procedure for a one-dimensional case. This Figure effectively shows the resampling process for a single output sample or pixel. Resampling is standard terminology in the art, such as discussed Heckbert P.S., Fundamentals of Texture Mapping and Image Warping, Master's Thesis, Dept. of EECS, Univertsity of California at Berkeley, 1989. In particular, the open circle represents the weight factor for input sample or texel t4. As shown, the procedure allows for negative input sample weights. At both ends of the filter characteristic, the response becomes zero.

This same approach can be used for individual images, also called textures “glued” on the polygons or other primitives in a three-dimensional scene. On the other hand, this approach will often break down near the edge of a primitive, because all the texels that should contribute to the particular final pixel should be available. This is not generally the case in a three-dimensional graphics pipeline of systems that comply to a standard immediate mode API like OpenGL or Direct 3D. These systems will generally process on a primitive-by-primitive basis, i.e., only the texels of a particular single primitive will be available at any given instant.

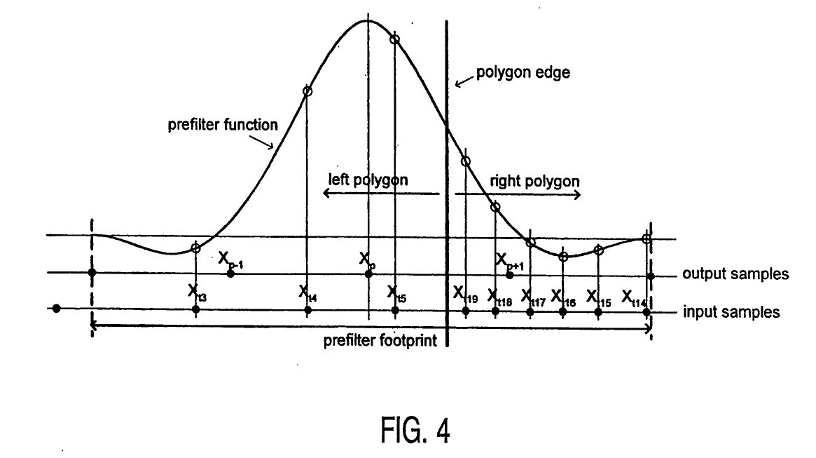

To illustrate this, FIG. 4 shows a diagram of a filtering procedure for a one-dimensional case. Here, a particular pixel will clearly need filtered colours from both polygons in the graph. Through correct theoretical procedures, a continuous signal may be constructed and used as an input signal for the pre-filter that rejects high-frequency components which cannot be displayed by the output display grid. In this way, high-frequency components from the texture images and from the polygon edges are treated in the same manner. Super sampling may be viewed as a coarse approximation of this approach: in fact, super sampling applies the filter profile during downscaling to the desired resolution on the sub-samples that may be derived from different primitives such as polygons.

Now, according to the present invention, the pixel colours will be calculated at the desired output resolution. All polygons that have an overlap with the prefilter footprint regarding a particular pixel, will in principle indeed contribute to that pixel. The determination which pixel's prefilter footprints are effectively overlapped is complex under application of a traditional inverse mapping procedure, which may be considered as an output-driven filtering procedure. It is easier under application of forward mapping, which is an input drive filter procedure. In consequence, the present embodiment is combining the above with an input driven filter procedure that accumulates a texel's contribution to a group of pixels, by “splatting” or transposed direct form filtering. This will straightforwardly yield all contributions to a particular pixel. The determining of which texels will fall within the effective prefilter footprint overlap with the polygon is done implicitly, as distinguished from the procedure of inverse mapping that does so explicitly. In the input driven calculation, a texel may contribute to several output pixels. A certain pixel will be finalized if all texels in the prefilter footprint have been processed. FIG. 4 shows an example of two polygons contributing to a single output pixel.

Note that in a three-dimensional graphics system that operates an immediate mode API, the neighbouring relations among the various polygons are in general not known, so that the combinations of these several polygons that will contribute to a particular single pixel are not trivial to compute.

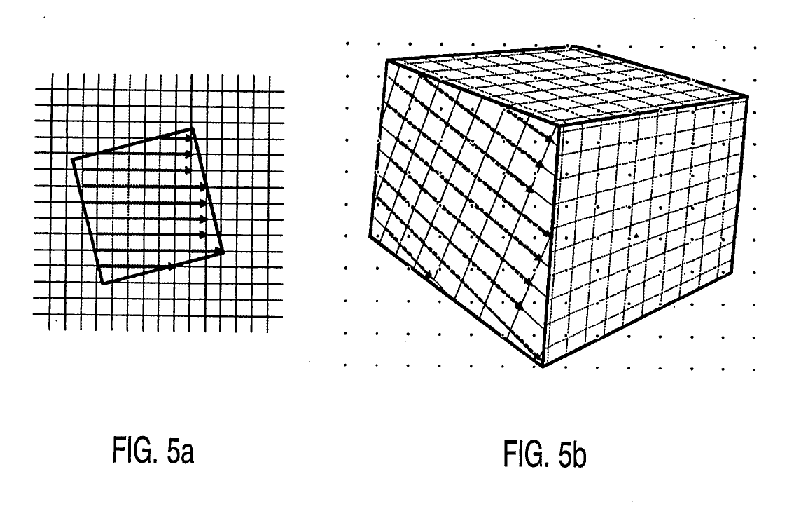

The edge anti-aliasing technique can be combined with either single-pass or two-pass forward texture mapping techniques. In a somewhat more complicated way, also combination with the traditional inverse texture mapping techniques is feasible. As a first example, minification is herein discussed with respect to a one-pass forward texture mapping method combined with an input-sample-driven pre-filtering. In this respect, FIGS. 5a, 5b illustrate an exemple of rasterization in texture space.

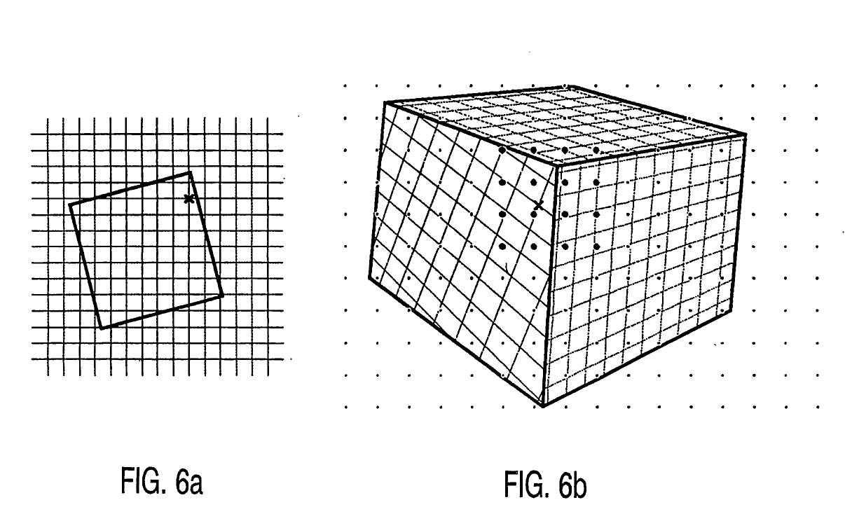

Now, forward mapping rasterizes a polygon in texture space. Although most rasterizers operate on the basis of triangles, the Figure assumes a rasterizer on the basis of a quadrilateral. The transition from a rectangle to a triangle is straightforward to implement. In FIG. 5a, the square represents the texture area to be associated to the left-facing side surface in FIG. 5b. In FIG. 5a, the texel coordinates are defined at the crossing points of the texture grid lines. The pixel coordinates have been indicated by small dots on the grid pattern in FIG. 5b's screen space. Within the square cutout of the texture, the forward texture mapping rasterizer traverses all texels. Each texel's coordinates are mapped to (x,y)-defined screen coordinates. In FIG. 5b, the dashed arrows represent the mapped texel spans that are so traversed. In FIGS. 6a, 6b, the crosses represent the mapping of a particular texel from texture space to screen space.

FIG. 6b illustrates the pixels that have contributions from the particular texel shown in FIG. 6a. These are determined on the basis of the mapped texel coordinates. Pixels whose prefilter footprint has an overlap with the mapped texel coordinate are to be contributed, weighted according to the location within the prefilter footprint. In particular, pixels with a contribution from the crossed texel have been marked with relatively bigger dots. The input-driven procedure to distribute the contributions from input texels over output pixels through using a filter profile can best be explained by way of a one-dimensional example.

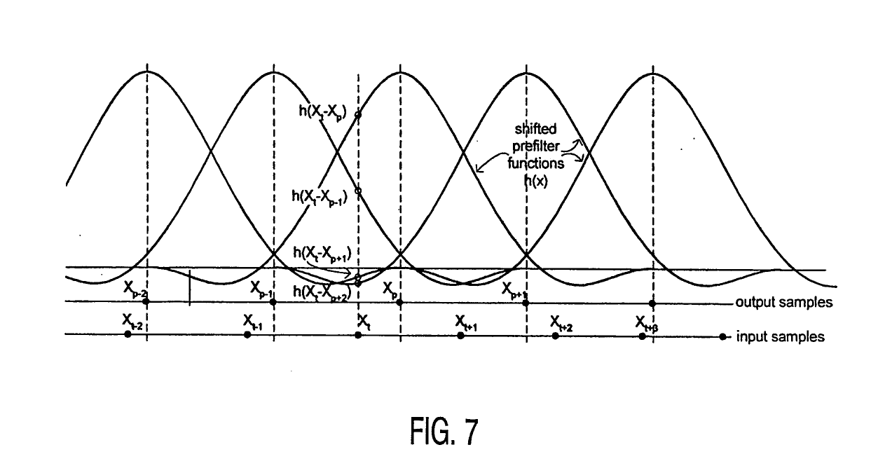

FIG. 7 by way of example illustrates the contributions from various texels in a one-dimensional case. It can be seen that the texel in this case will contribute to the four pixels that lie closest to the mapped texel coordinate. The number of pixels to contribute to is equal to the unit width (or area in 2D) of the filter footprint (when applying minification). This way of filtering can be done very efficient in ID. In that case, the video filter technique called “transposed direct-form polyphase FIR filter structures” can be used. Two-dimensional texture mapping and filtering can be efficiently done through two successive 1D filter passes which, however, will not be further considered in this section.

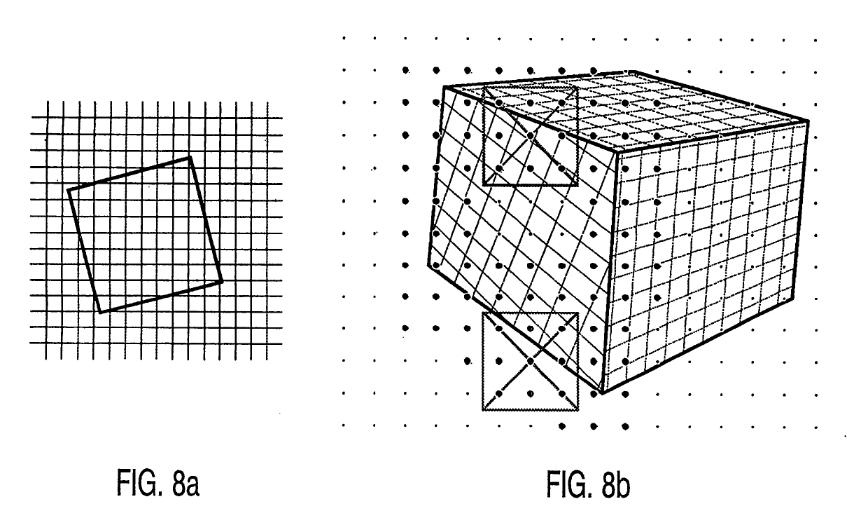

The input-driven procedure has the advantage that pixels within the “edge region” of the current polygon (wherein the pixel's prefilter footprint in part overlaps this polygon) will get a “partial” pixel colour. This partial pixel colour will then be completed with partial colour derived from one or more further adjacent polygons, or background polygons in case of a silhouet edge. In this respect, FIGS. 8a, 8b illustrate the positions of left face “edge pixels” of a polygon. By way of example, the square footprint of the prefilter has an area of 3×3. In FIG. 8b, for two pixels, one inside, and one outside the polygon border, the prefilter footprint has been indicated as a square with a large cross inside. Only the texels of the current polygon that fall inside the prefilter footprint should contribute to the pixel in question, but not the texels falling outside the polygon border in the texture space.

To be even more precise and explicit, only the texture signal inside the polygon border should be used. When however, a higher order reconstruction filter is used, also texels outside the polygon borders may contribute to the signal inside the polygon border, thereby further contributing to the pixel in question.

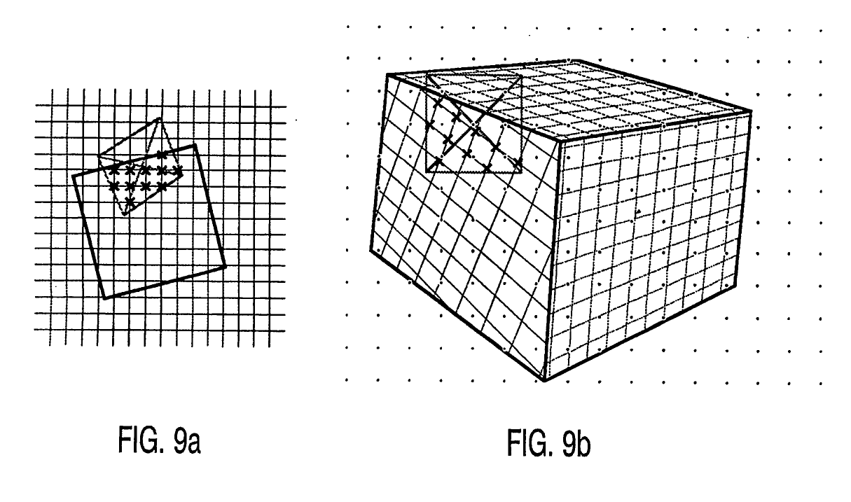

This is shown more in particular in FIGS. 9a, 9b that illustrate the same for only the texels in the prefilter footprint and within the polygon that should contribute. Each time the original texel positions and their counterparts in pixel space have been indicated by small crosses.

The polygon contribution for a pixel is the sum of the texel contributions whose texel coordinates are mapped within the pixel's prefilter footprint. The texel colour contributions are accumulated to a single value during rasterization of the polygon in question. We propose to store these polygon-to-pixel contribution values in the fragment buffers shown in FIG. 2, to be able to correctly combine the final pixel colour in a post-processing step after all polygons have been rendered. The polygon-to-pixel contribution values consist of (partial) colours, a contribution factor (the summed weight of all contributing texels), a depth value, and maybe even further data not considered here. We will call this a pixel fragment.

Additionally, it is also feasible to apply the edge anti-aliasing method described hereabove to traditional inverse texture mapping. To this end, the traditional filters can be extended to output also partial colours in case the prefilter footprint only partially covers the polygon in question.

A further common per-fragment operation is the so-called α-test, wherein the information in an α-channel is used to determine whether a particular colour should contribute or not. Traditionally, this α-test is performed as a per-fragment operation. It may be advantageous to perform the α-test per on a per texel basis instead, i.e., before filtering. In this case, if a particular texel fails the α-test, its contribution to that pixel is set to zero, even if the texel falls within the pixel's prefilter footprint. In this way, the prefilter is also used to anti-alias the edges specified by the α-test. Preferably, the α-test operation in the pixel fragment operation module is positioned just before the filter unit.

1. A method for executing a computer graphics processing operation on information relating to a model of one or more three-dimensional objects, wherein said model includes texture information,
said method including a rendering step that comprises a transformation step allowing for both affine and non-affine two-dimensional image transformations, and therewith comprising transforming said texture information, through using a filtering step to suppress aliasing artifacts of interior parts of one or more textured primitives in the rendered image,
said method being characterized in that the filtering is also used to deliver partial colours at both sides of the edges of such primitive, and wherein aggregation of such partial colours is used for suppressing artifacts from edge aliasing of the primitive in question.

2. A method as claimed in claim 1, wherein said primitives include one or more of the following set: triangles, quadrilaterals, other polygons, and surfaces with curved edges such as Bezier patches.

3. A system being arranged for implementing a method as claimed in claim 1 and comprising a rendering module that comprises a transformation element allowing for both affine and non-affine two-dimensional image transformations for transforming said texture information, and comprising filtering means for executing a filtering step to suppress aliasing artifacts of interior parts of one or more textured primitives in the rendered image,
said method being characterized in that the filtering means are also arranged to deliver partial colours on both sides of the edges of a primitive, that are used for suppressing artifacts caused by edge aliasing of the primitive in question.

4. A system as claimed in claim 3, wherein said transformation element comprises a polyphase FIR filter.

5. A system as claimed in claim 3, wherein the calculations in said filtering means are effected on texture coordinates that have been transformed to an output space.

6. A system as claimed in claim 3, wherein the calculations in said filtering means are effected on output sample coordinates that have been transformed to an input space.

7. A system as claimed in claim 3, wherein the calculations in said filtering means are effected as being driven by input samples before transforming.

8. A system as claimed in claim 3, wherein the calculations in said filtering means are effected as being driven by output samples.

9. A system as claimed in claim 3, and furthermore comprising an interface to remote presentation means for therefrom receiving said model information.

10. A system as claimed in claim 3, wherein the α-test operation is performed just before the filtering.

11. A system as claimed in claim 3, wherein the edge anti-aliasing technique is combined with either a single-pass or with a two-pass forward texture mapping technique.

12. A system as claimed in claim 3, wherein the edge anti-aliasing technique is combined with a traditional inverse texture mapping technique.
